(19) United States
(12) Patent Application Publication
(10) Pub. No.: US 2014/0291242 A1
(43) Pub. Date: Oct. 2, 2014

(54) MEMBRANE MODULE FOR ORGANOPHILIC PERVAPORATION

(71) Applicants: Heiko Notzke, Glinde (DE); Torsten Brinkmann, Geesthacht (DE); Thorsten Wolff, Geesthacht (DE); Ulrike Withalm, Hamburg (DE); Jan Wind, Lauenburg (DE); Patrick Schiffmann, Dresden (DE); Jens-Uwe Repke, Berlin (DE); Heike Matuschewski, Neuenhagen (DE)

(72) Inventors: Heiko Notzke, Glinde (DE); Torsten Brinkmann, Geesthacht (DE); Thorsten Wolff, Geesthacht (DE); Ulrike Withalm, Hamburg (DE); Jan Wind, Lauenburg (DE); Patrick Schiffmann, Dresden (DE); Jens-Uwe Repke, Berlin (DE); Heike Matuschewski, Neuenhagen (DE)

(21) Appl. No.: 14/234,054

(22) PCT Filed: Jul. 16, 2012
(86) PCT No.: PCT/EP2012/002984

§ 371 Date: Jun. 16, 2014

(30) Foreign Application Priority Data
Jul. 22, 2011 (EP) 10 2011 079 647.9

(51) Int. Cl. B01D 61/36

(52) U.S. Cl. CPC B01D 61/362
USPC 210/640; 210/188

(57) ABSTRACT

The invention relates to a membrane module for pervaporation, in particular organophilic pervaporation, having a liquid-tight housing with at least one feed inlet, at least one retentate outlet and at least one permeate outlet that is or can be subjected to a negative pressure or vacuum, wherein a membrane pocket stack is arranged in a housing interior and has a plurality of membrane pockets and seals laid on one another, wherein mechanical pressure is or can be applied to the membrane pockets in the stacking direction by means of a pressure application device for the mutual sealing of the membrane pockets, so that the housing interior is divided up by the membrane pockets into a feed chamber on the outside of the membrane pockets and a permeate chamber in the interior of the membrane pockets. The invention further relates to a use of a membrane module according to the invention.

The invention relates to a membrane module for pervaporation, in particular organophilic pervaporation, having a liquid-tight housing with at least one feed inlet, at least one retentate outlet and at least one permeate outlet that is or can be subjected to a negative pressure or vacuum, wherein a membrane pocket stack is arranged in a housing interior and comprises a plurality of membrane pockets and seals laid on one another, wherein mechanical pressure is or can be applied to the membrane pockets in the stacking direction by means of a pressure application device for the mutual sealing of the membrane pockets, so that the housing interior is divided up by the membrane pockets into a feed chamber on the outside of the membrane pockets and a permeate chamber inside the membrane pockets. The invention further relates to a use of a membrane module according to the invention.

Pervaporation is a method for cleaning liquid mixtures, based on a separation effected by membranes with different permeability for different liquid components diffusing through said membranes. For each application, a suitable membrane must be selected which promotes diffusion of the component that is present at a lower concentration, also called the minority component, rather than that of the majority component, which is present in excess. An example is the separation of ethanol fuel containing, for example, 96% by weight of ethanol and 4% of water, i.e. an azeotropic mixture that cannot be separated further by other separation processes. For this purpose, a hydrophilic membrane may be selected which facilitates entrance of the minority component, i.e. water, and tends to repel ethanol.

In contrast to filtration processes driven by pressure, the membrane is impermeable to the liquids in question, except by way of diffusion. To carry out pervaporation, a negative pressure or vacuum is applied on the permeate side, while a feed flow generated on the feed side is not associated with a particular pressure.

Pervaporation is driven by the fact that the liquid components of the feed flow diffuse through the membrane and meet with a high negative pressure or a vacuum on the permeate side. As a result, the permeate will instantly evaporate on the permeate side of the membrane and move on to the permeate outlet. This pressure difference between the vacuum or low air pressure on the permeate side and the normal liquid pressure on the feed side, which is the retentate side at the same time, drives the diffusion process or pervaporation process. This process can also be viewed from the aspect of the concentration of the solution component diffusing through the membrane since the concentration of said liquid component is high on the feed side of the membrane and low on the permeate side due to evaporation on the permeate side. The resulting concentration gradient drives the pervaporation process. Therefore, pervaporation goes on at a rate that depends on the pressure difference between the two sides of the membrane at any point on the membrane.

The state of the art comprises different structures of membrane modules designed for pervaporation. Most membrane modules are based on flat membranes. For example, a plate module which is available from the company Sulzer-Chemtech and includes an open permeate chamber comprises a membrane that is mounted between a feed plate and an end plate of the module, and a permeate channel spacer that is arranged on the permeate side and includes a perforated metal sheet. A complex seal is required in this case.

In a plate module which is available from the company CM-Celfa and includes a closed permeate chamber, membrane plates alternate with impermeable plates, which also requires complex sealing measures.

In an alternative structure, alternating layers of flat membranes are wound around a central porous permeate tube in a spirally wound module, and alternating layers of feed spacer and of permeate spacer are arranged between them. The feed flow is introduced parallel to the permeate tube. This structure is not fully suitable for use in pervaporation processes.

Finally, the applicant has developed a membrane module for pervaporation on the basis of a membrane pocket stack including round membrane pockets that are welded to one another on their edges and stacked on a central porous permeate tube. To this end, the membrane pockets with a round cross-section each have a central round opening whose radius is the same as the diameter of the permeate tube. The membrane pockets, each including two membrane surfaces lying on one another, are kept open by permeate spacers inside the membrane pockets, so that the membrane pockets will not collapse when a negative pressure is applied in the permeate tube. In addition, the membrane pockets are sealed at their contact lines, along with the permeate tube, in such a manner that the outsides of the permeate pockets form a feed chamber in the membrane module, which feed chamber is sealed from a permeate chamber on the inside of the membrane pockets and from the permeate tube.

In contrast to the above, it is the object of the present invention to provide a membrane module for pervaporation which achieves a more improved separation efficiency, in particular an increased amount of permeate, while maintaining consistently good selectivity.

This object is achieved by a membrane module for pervaporation, in particular organophilic pervaporation, having a liquid-tight housing with at least one feed inlet, at least one retentate outlet and at least one permeate outlet that is or can be subjected to a negative pressure or vacuum, wherein a membrane pocket stack is arranged in a housing interior and comprises a plurality of membrane pockets and seals laid on one another, wherein mechanical pressure is or can be applied to the membrane pockets in the stacking direction by means of a pressure application device for the mutual sealing of the membrane pockets, so that the housing interior is divided up by the membrane pockets into a feed chamber on the outside of the membrane pockets and a permeate chamber inside the membrane pockets, which membrane module is improved due to the fact that the membrane pockets have a substantially rectangular cross-section and, in their membrane surfaces, have openings in the form of slots, wherein the slot-like openings arranged on one another in the membrane pocket stack and the seals located therebetween form at least one common permeate channel which leads to the at least one permeate outlet.

The basic idea which underlies the invention is that a membrane module developed by the applicant, including a membrane pocket stack of substantially round membrane pockets and with a circular central opening for a central permeate tube, is modified by changing its geometry in such a manner that a greater pressure difference between the permeate side and the feed side of the membrane is achieved. In conventional membrane modules using flat membranes, this problem did not exist since the pressure difference between the permeate side and the feed side was the same throughout the flat membrane. In case of the round membrane pockets of the membrane module developed by the applicant, the problem was not known to exist since separation efficiencies were comparable to or even exceeded those of conventional state-of-the-art modules with regard to both selectivity and permeation rate. However, it has surprisingly been found that the rate of permeation through the membranes can be greatly increased further by changing the geometry.

This is based on the fact that permeate located at a radially outer point of a round membrane pocket must flow towards the centre, i.e. the permeate tube, as a gas. This is true of permeate flowing inwards from any point of the membrane pocket. Towards the central permeate tube, the permeate gradually reduces in volume, i.e. it is compressed as it moves towards the centre. Said compression is accompanied by an increased resistance and a pressure loss. The result is a great pressure difference from the outer portions of the membrane pockets towards the centre, so that the negative pressure applied on the permeate side of the membrane is lower in the outer portions than at the centre. Consequently, the force driving diffusion of the liquid minority component in the membrane is much less strong in the outer portion of the membrane pocket than in the inner portion where the pressure difference between the permeate side and the feed side of the membrane is greater than in the outer portion. This leads to inefficiency of the pervaporation process in the outer portion of the membrane, i.e. in the part of the membrane pockets covering a larger area. The pressure loss curve is particularly steep in the inner portion of the membrane pockets, while it becomes much flatter towards the outside. Therefore, a large part of the membrane surface lacks efficiency.

In these considerations, the thickness of the membrane pockets, i.e. the distance between the membranes of the membrane pockets, is only of minor importance since it is kept constant in the radial direction by means of permeate spacers. The increasing pressure loss is mainly due to a change in size of the membrane pocket in the circumferential direction, which can be illustrated by means of concentric circular rings of the same thickness, the surface area of which decreases linearly as the radius becomes smaller.

If a substantially rectangular cross-section for the membrane pockets and a slot-like opening are selected, the flow structures of the permeate in the membrane pockets will change. Instead of flowing radially from the outside towards a centre, which entails a reduction in cross-section, the permeate now reaches the central slot along a straight path with hardly any reduction in cross-section. Converging flow lines, which bring about a similar pressure loss are only found in the immediate vicinity of the end portion of the slot(s). However, the flow lines do not converge or only slightly converge along the length of the slot, whereby the pressure loss from the inside outwards is significantly reduced in the membrane pockets. As a result, similarly low values of negative pressure are applied in a major part of the surface area of the membrane pockets, so that a great pressure difference between the permeate side and the feed side of the membrane prevails in these portions, thus ensuring high-efficiency pervaporation. In this way, the pervaporation rates that can be achieved, i.e. the amounts of permeate, can be increased several times without adversely affecting the selectivity of the separation of the minority component and the majority component.

Preferably, the slot-like openings are arranged on the longer one of the two axes of symmetry of the membrane pockets. This measure serves to maximize the portions of the membrane pockets where non-converging permeate flows are present and to minimize portions where permeate flow lines converge. This improves the efficiency of pervaporative separation.

In an advantageous further development, the at least one permeate channel opens into a permeate tube which is located on one side of the membrane pocket stack and has one or several permeate outlet(s). In this case, the vacuum is not applied directly to a permeate channel in the membrane pocket stack but to a permeate tube on one side or both sides of the permeate tube, which simplifies the overall design of the membrane module. In this way, the slot-like cross-section of the permeate channel(s) in the membrane pocket stack changes into a tube-like cross-section, which is more suitable for applying a negative pressure.

Instead of one slot-like permeate channel, several slot-like permeate channels arranged next to each other in a row may be provided. This is, in particular, the case in an embodiment of the membrane module where the pressure application device comprises tie rods extending from one side of the membrane pocket stack to the other side of the membrane pocket stack while being arranged in an axis of symmetry of the membrane pockets in order to ensure that pressure is built up as uniformly as possible, for example by means of a pressure plate. In such a case, the slots of the permeate channels and the tie rod(s) alternate on said axis of symmetry.

Preferably, porous permeate spacers are arranged in the membrane pockets, and/or porous feed spacers are arranged between the membrane pockets in the membrane pocket stack. The porous permeate spacers serve to prevent the membrane pockets from collapsing when negative pressure is applied, and thus to define an unchanging permeate chamber in the membrane pockets. The permeate spacers are porous and have sufficient strength to maintain the shape of the membrane pockets even when negative pressure is applied. The feed spacers serve to stabilize the membrane pockets, in particular with regard to the feed flow in the membrane module. As a result, a constant geometry of the membrane pocket stack is maintained while also ensuring that the membranes of successive membrane pockets do not contact one another, so that the surface area available for pervaporation is as large as possible.

Advantageously, several permeate spacers are arranged in layers in the membrane pockets, and the fineness of said permeate spacers as regards their porosity increases from the inside outwards. For example, a layer of a coarse permeate spacer, e.g. made of polymer threads laid on one another crosswise, may be provided at the centre, in terms of thickness of the membrane pockets, while said polymer threads reduce in thickness towards the outside and, if appropriate, a fine fibre web is arranged in an outermost layer, which web has a certain small-space flexibility and, in particular, a relatively small surface contacting the permeate side of the membrane of the membrane pockets, so that the flow area which is actually available for pervaporation on the permeate side of the membranes is as large as possible.

For further stabilization of the membrane pocket stack and of the permeate channel(s), one or more metal pressure plate(s) is/are arranged as an addition between the membrane and a permeate spacer between the membrane pockets. Said metal pressure plates absorb the compressive loads exerted on the membranes by the seals arranged between the membrane pockets and form an abutment for said seals. As a result, the feed chamber and the permeate chamber are sealed from one another even more tightly.

Furthermore, a perforated support tube is arranged in the at least one permeate channel in order to stabilize said permeate channel(s), which support tube has substantially the same cross-section as the permeate channel. Such a support tube prevents seals or parts of membrane pockets from being drawn inwards due to the negative pressure applied inside the membrane stack, which would cause breakage of the sealing between the feed chamber and the permeate chamber inside the housing. In this case, the feed liquid would have unrestricted access to the permeate chamber. A support tube reliably prevents such an event.

In an advantageous further development of the membrane module according to the invention, the housing interior is divided into several sections or compartments by means of baffle plates arranged between individual membrane pockets, wherein said baffle plates each comprise openings for passing a feed flow from one compartment to the next, said openings being arranged so as to alternate in order to achieve a meandering feed flow through the compartments. If the feed flow is made to meander, said feed flow will successively be passed across several membrane pockets in each of the compartments following one another, so that the effective membrane surface met with by said feed flow is multiplied. This improves the efficiency of pervaporative separation of the liquid mixture even further.

Preferably, as another further development, the height of the compartments and the number of membrane pockets per compartment decrease at least partially in the direction from the feed inlet to the retentate outlet. This results in a continuous reduction of the cross-section available to the feed flow inside the housing from the feed inlet to the retentate outlet, leading to a higher flow velocity. This also means that initially, near the feed inlet, the concentrated feed liquid remains on a comparatively large number of membrane pockets, and thus a large membrane surface, for a comparatively long time, thus separating a comparatively large amount of the minority component from the liquid mixture already at the beginning. In the following compartments, the flow velocity is higher due to the reduced height of the compartments, and the number of available membrane pockets per compartment is lower and thus the available membrane surface is smaller, so that an increased pervaporation of the majority component of the liquid mixture, which has concentrated in the meantime, is prevented in this region. The invention also comprises any other distribution of the numbers of membrane pockets per compartment, for example a reduction changing into an increase in the number of membrane pockets per compartment towards the retentate outlet. This variation can be adjusted according to requirements.

In the membrane module according to the invention, the housing is preferably arranged in a pressure vessel.

Furthermore, the object of the invention is also achieved by means of a use of a membrane module according to the invention, described above, for pervaporative separation of liquid mixtures, in particular mixtures of organic solvents and organic substances dissolved therein.

The features, advantages and characteristics mentioned in the context of the membrane module according to the invention are, without limitation, also true of the use of said membrane module according to the invention.

Further features of the invention will be apparent from the description of embodiments of the invention in conjunction with the claims and the appended drawings. Embodiments of the invention may either comprise individual features or a combination of several features.

The invention will hereinafter be described by means of exemplary embodiments, without limitation of the general inventive idea, with reference to the drawings, wherein the reader is expressly referred to the drawings for all details of the invention not elaborated in the text. In the figures:

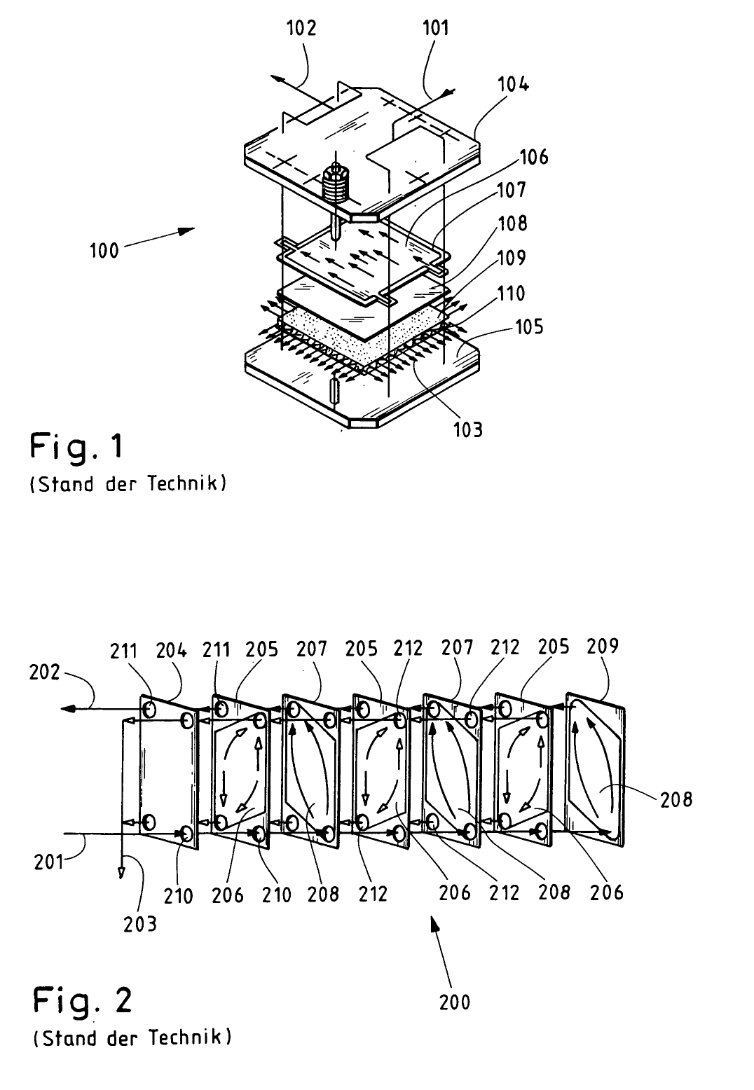

FIG. 1 shows a schematic view of a plate module according to the state of the art,

FIG. 2 shows a schematic view of another plate module according to the state of the art,

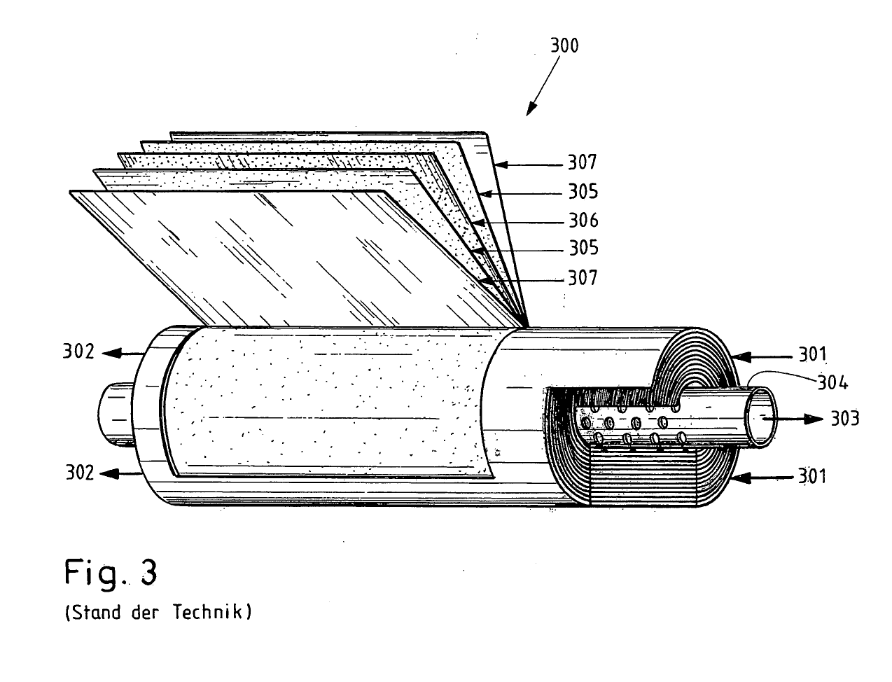

FIG. 3 shows a schematic view of a spirally wound module according to the state of the art,

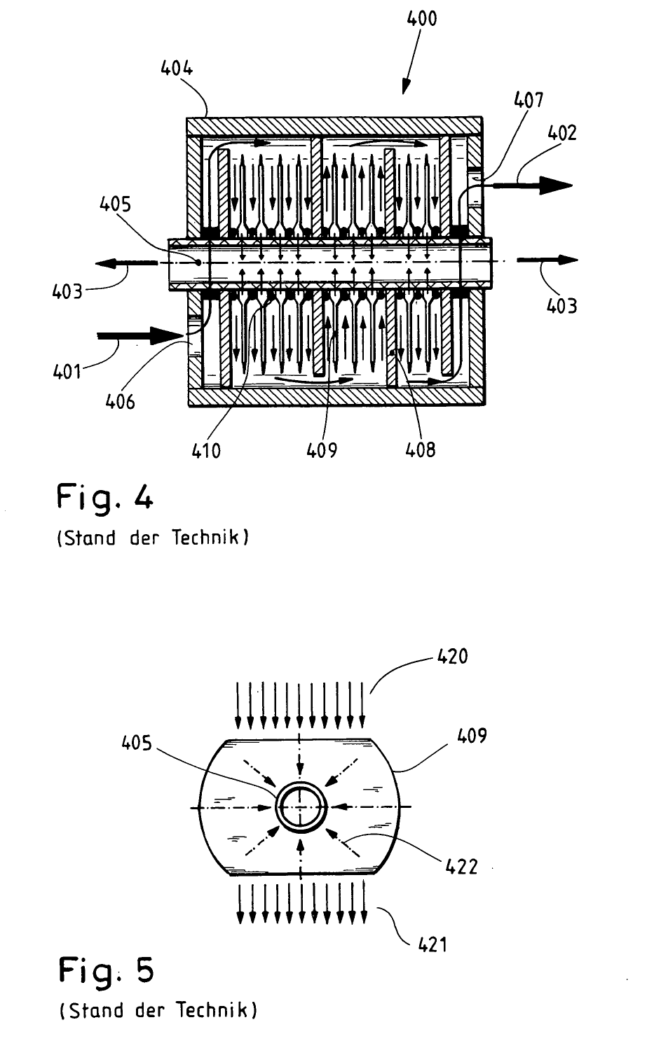

FIG. 4 shows a schematic cross-sectional view of a known membrane pocket module,

FIG. 5 shows a schematic view of a known round membrane pocket,

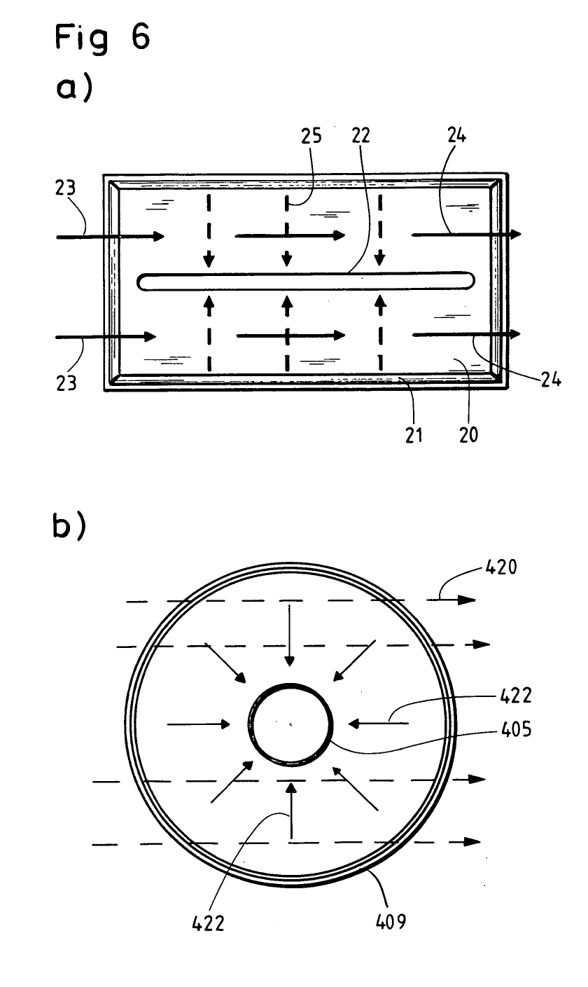

FIGS. 6a), 6b) show a schematic view of the flow lines in membrane pockets,

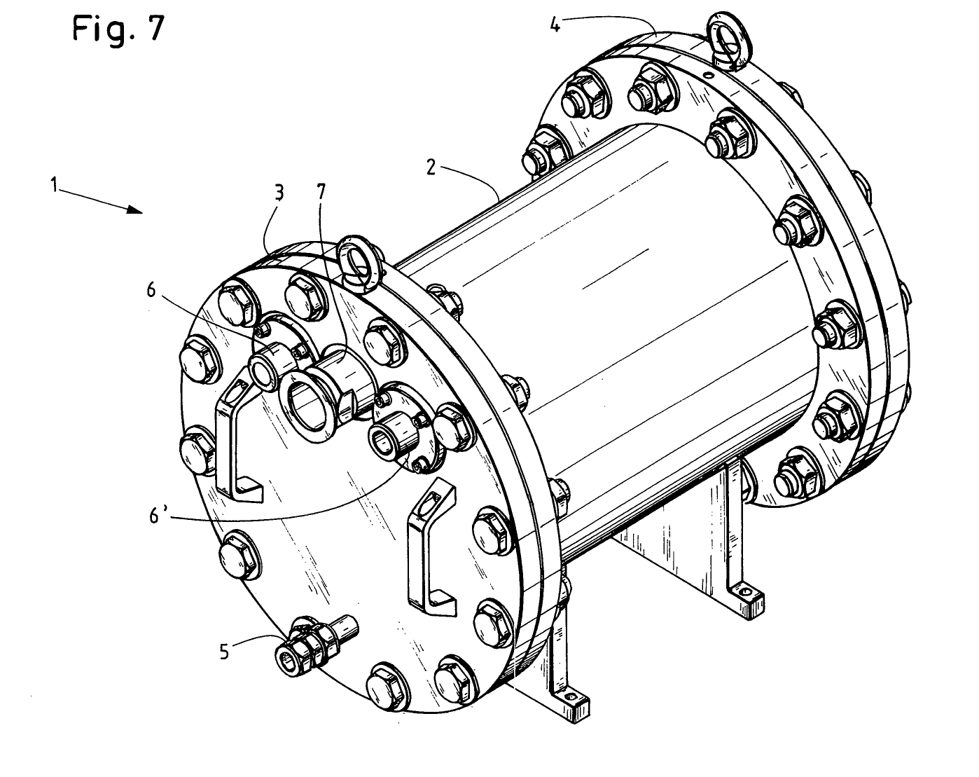

FIG. 7 shows a perspective view of a pressure vessel of a membrane module according to the invention,

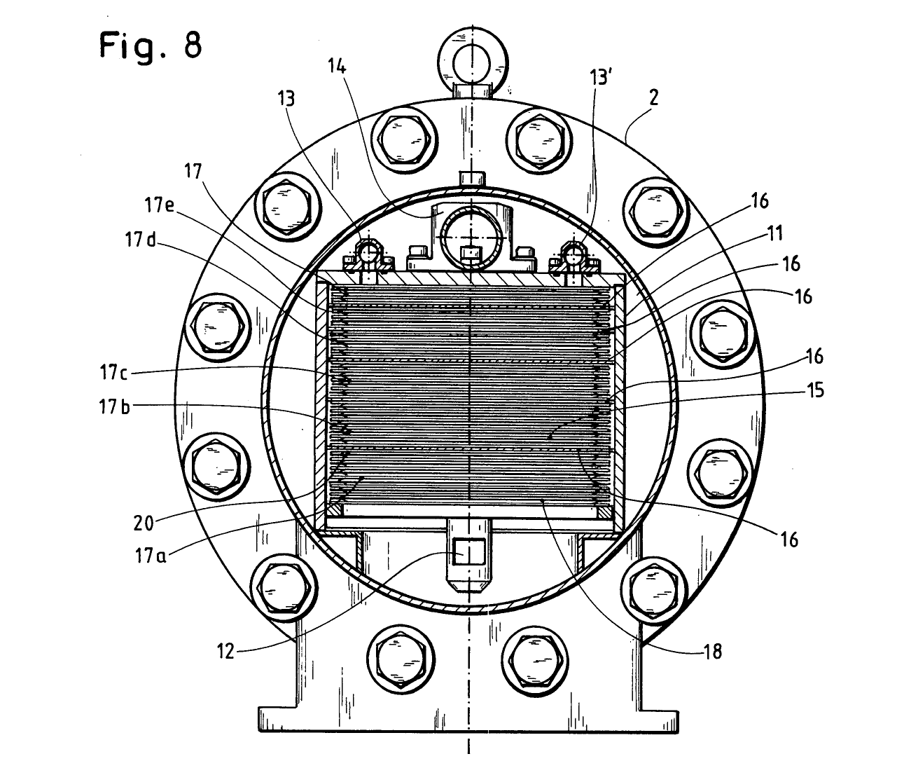

FIG. 8 shows a schematic front view of a membrane module according to the invention,

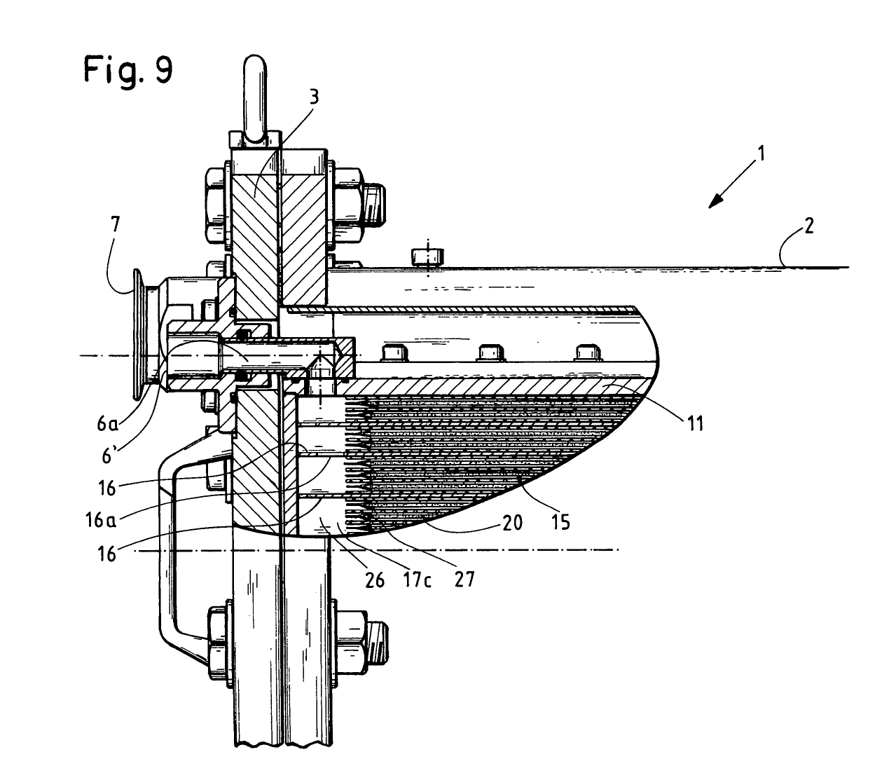

FIG. 9 shows an elevational view of a membrane module according to the invention,

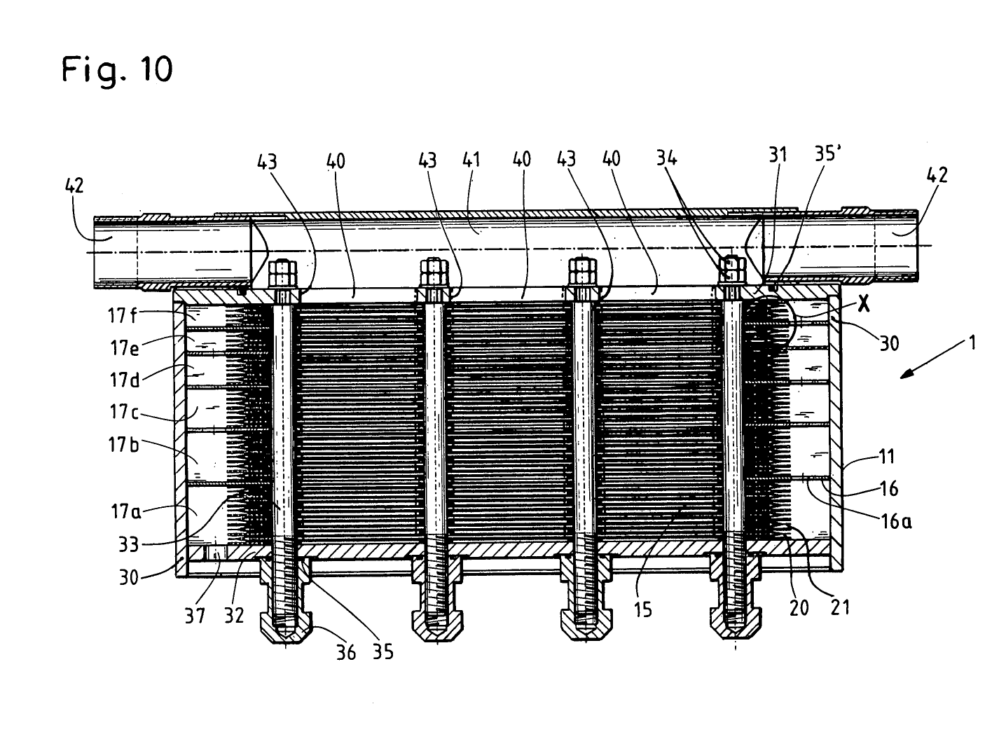

FIG. 10 shows a side cross-sectional view of a membrane module according to the invention,

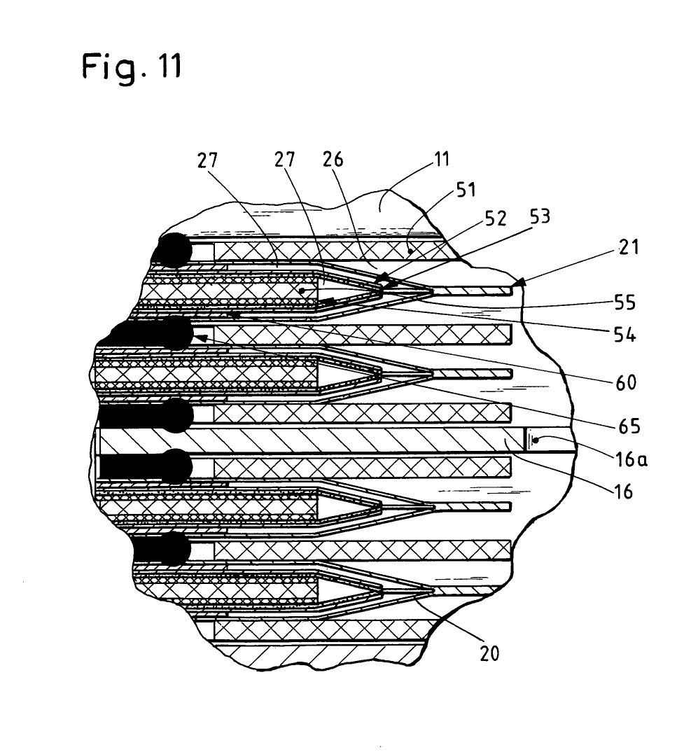

FIG. 11 shows a detailed schematic view of a cross-section of a membrane module according to the invention,

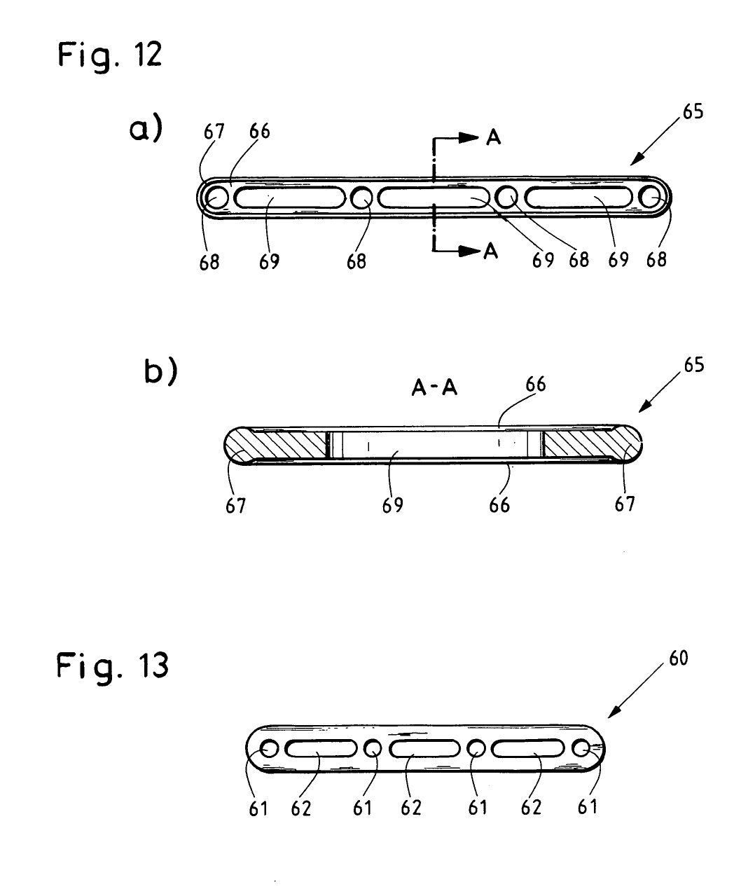

FIG. 12 shows schematic views of a seal, and

FIG. 13 shows a schematic view of a metal pressure plate.

In the drawings, identical or similar elements and/or parts are provided with the same reference numerals and their description will not be repeated.

FIG. 1 shows, in exploded form, a schematic perspective view of a plate module 100 which is available from the company Sulzer-Chemtech and includes an open permeate chamber. A feed plate 106 including a continuous seal 107, a membrane 108 and a perforated metal sheet 109 with an adjoining permeate channel spacer 110 are arranged in a sealing manner between an upper plate 104 and a lower plate 105. To this end, the upper plate 104 and the lower plate 105 are tightly screwed to one another, and the layers arranged between them are subjected to pressure at the continuous seal 107, thus sealing them towards one another.

The upper plate 104 is provided with inlets for a feed 101 of a liquid mixture containing a minority component and with an outlet for a retentate 102 on the opposite side. In addition, it is shown at the lower side that permeate exits in different directions through the permeate channel spacer 110 through the permeate channel 103. Here, the continuous seal 107 must have a complex design to ensure that the feed chamber is reliably sealed from the permeate chamber.

FIG. 2 shows, in an exploded form, a schematic view of a plate module 200 which is available from the company CM-Celfa and includes a closed permeate chamber. The plate module 200 comprises a stack or tower made up of a cover plate 204, alternating membrane plates 205 and intermediate plates 207 and a final end plate 209, which are shown at a distance from one another in order to elucidate the functional principle but are actually arranged on one another in the plate module 200 in a sealing manner. The plates 204, 205 and 207 are each provided with openings for feed channels 201, retentate channels 211 and permeate channels 212 at their corners, for passage of a feed 201, a retentate 202 and a permeate 203 respectively.

The membrane plates 205 each have a rhomboid membrane 206, which is connected to the openings for the permeate channels 212. Together with the intermediate plates 207 surrounding it, each membrane 206 divides the space between two successive intermediate plates 207 into a feed chamber and a permeate chamber. A feed liquid flows through each feed chamber, in the transverse direction from the feed channel 201 to the opposite retentate channel 211. In the permeate chamber, the permeate diffuses from the entire membrane surface to the two permeate channels 212. The flow arrows for liquids are each provided with an arrow point coloured black, while the flow arrows for the gaseous flows, i.e. the permeate, are provided with a white arrow point.

FIG. 3 shows a schematic view of a membrane module according to an alternative design principle, specifically a spirally wound module 300 including a perforated tube 304 at the centre. Said tube is surrounded by two sheet-like membranes 305 which are wound in a spiral manner and between which a permeate spacer 306 and a feed spacer 307 respectively are arranged in an alternating manner. In this spirally wound module 300, a feed 301 is introduced into the spiral membrane part in the direction of the perforated tube 304, which feed exits on the other side as retentate 302. Permeate enters the porous tube 304 from the gap between the membranes 305, which is filled with the permeate spacer 306, and exits from the tube 304 as retentate 302.

FIG. 4 is a schematic cross-sectional view of a membrane module 400 including a stack of membrane pockets 409, which has been developed by the applicant. Said module comprises a container 404 or a housing provided with a feed inlet 406 for a feed 401, which is made to meander through the container 404 by baffle plates 408 arranged in an alternating manner on different walls of the container 404 and exits from a retentate outlet 407 as retentate 402. Inside the container 404, a stack of membrane pockets 409 is arranged, which are arranged around a central permeate tube 405 and are sealed towards the feed 401 by means of O rings 410.

The membrane pockets 409 of the pervaporation module 400 shown in FIG. 4 have a substantially round circumference, and the central opening containing the permeate tube 405 is circular. The feed 401 is made to meander through the container 404 in such a manner that it flows along the outer surfaces of the membrane pockets 409 in each case. The minority component diffuses through the membranes of the membrane pockets 409 to a greater extent than the majority component of the feed 401, and reaches the inner side of the membranes where it evaporates, and flows to the permeate tube 405 and is sucked off at the ends of the permeate tube 405 as gaseous permeate 403.

FIG. 5 shows a schematic top view of a membrane pocket 409 of the pervaporation module 400 according to FIG. 4. The membrane pocket 409 is shown round in parts in FIG. 5, but two parallel straight side lines are present as well. The central opening containing the permeate tube is circular. The arrows having a solid line show that a feed flow 420 flows to the membrane pocket 409 from one side, flows across said membrane pocket and then continues as retentate flow 421.

The arrows having a dash-dotted line show the direction of flow of the retentate evaporating inside the membrane pocket 409, i.e. the permeate flow 422. It can be clearly seen that the permeate flow 422 is directed towards the centre from all directions.

FIGS. 6a) and 6b) are schematic views illustrating the flow conditions in a membrane pocket 20 according to the invention, having a rectangular cross-section and a slot 22, and in a conventional round membrane pocket 409 as is also shown in FIG. 5. While a permeate flow 422 whose flow lines converge towards the central permeate tube 405 is observed in case of the round membrane pocket 409 shown in FIG. 6b), the flow lines of the permeate flow 25 in FIG. 6a) are parallel to one another. Said flow lines continue to be parallel to one another until they nearly reach the side surfaces of the membrane pocket 20. Only in the immediate vicinity of the side surface, a few converging flow lines will form (not shown). However, this phenomenon only affects a small, peripheral part of the membrane pocket 20.

In contrast, the flow lines of the retentate flow 422 of the round membrane pocket 409 shown in FIG. 6b) all converge. Unlike the parallel flow lines shown in FIG. 6a), this reduced flow area leads to an increased resistance to flow and consequently to an increased pressure loss from the inside outwards in the membrane pocket 409, which results in a reduced driving force for diffusion of the minority component of the liquid mixture contained in the feed through the membrane. In case of the rectangular membrane pocket 20 according to FIG. 6a), having parallel flow lines, the flow area does not reduce, so that there is much less resistance to flow. As a result, the pressure loss towards the outside is much smaller in the rectangular membrane pocket 20, so that there is also a high pressure difference between the permeate side and the feed side of the membrane in the outer portions of the rectangular membrane pocket 20, which pressure difference drives diffusion of the minority component of the feed through the membrane. This effect is achieved by combining the rectangular geometry of the membrane pockets and the geometry of the slots arranged in the membrane pockets 20.

FIG. 7 shows a schematic view of a membrane module 1 for pervaporation according to the invention, which module is, in particular, suitable for pervaporation of organic liquid mixtures, for example in order to separate benzol from higher molecular washing liquids or to clean ethanol fuel.

The membrane module 1 comprises a cylindrical pressure vessel 2 which is sealed by means of a front plate and a rear plate 4, both of which are screwed to annular end flanges of the pressure vessel 2. The front plate 3 includes a feed connection piece 5 arranged centrally, near the bottom, and two retentate connection pieces 6, 6′ arranged near the top, between which a permeate connection piece 7 is arranged at a central position. In the perspective view according to FIG. 7, a similar permeate connection piece in the rear plate 4 is not shown since it cannot be seen in the perspective.

FIG. 8 shows a front view of the membrane module 1 according to FIG. 7 without the front plate 3. An inner container 11 including a feed inlet 12 on the lower side and retentate outlets 13, 13′ and a permeate outlet 14 on the upper side is arranged in the cylindrical pressure vessel 2. This means the direction of flow of the feed is from bottom to top, from the feed inlet 12 to the permeate outlets 14. A membrane pocket stack 15 including a plurality of membrane pockets 20 is arranged in the inner container 11, wherein, in addition, baffle plates 16 divide the interior space 18 of the inner container 11 into several compartments 17a-17f, the height of which decreases in the direction of flow of the feed from bottom to top. However, the last two compartments 17e and 17f are of the same size.

FIG. 9 shows a partial elevation of a part of the membrane module 1. The cylindrical pressure vessel 2 is sealed by the front plate 3, which is screwed to a flange of the cylindrical pressure vessel 2. The elevation shows the inner container 11, including the membrane pocket stack 15, the baffle plates 16 and some compartments. The interior space opens into a retentate channel 6a, which opens into a retentate connection piece 6′. A permeate tube including a permeate connection piece 7 is located above the membrane pocket stack 15.

As can also be seen in FIG. 9, the baffle plates 16 have openings 16a for passing the feed from one compartment to the next. In addition, it can be seen how the membrane pockets 20 separate a feed chamber 26 outside the membrane pockets 20 from a permeate chamber 27 inside the membrane pockets 20.

FIG. 10 shows a schematic cross-sectional view of the complete inner container 11 of the membrane module 1 according to the invention. The inner container 11 comprises end plates 30 and side plates or side walls (not shown), as well as a top plate 31 and a lower pressure plate 32, which are connected to one another by means of several tie rods 33. To this end, each tie rod 33 is secured by means of nuts 34 on its upper side and by means of tensioning nuts 36 on the opposite end, which exert pressure on the pressure plate 32 in conjunction with O rings 35. The pressure exerted on the pressure plate 32 by means of the tie rods 33 can be increased by tightening the screw nuts 34. If the tie rods 33 are adjusted to a uniform pre-tension, a uniform pressure can be exerted on the membrane pocket stack 15. Another O ring 35′ seals the top plate 31 from the exterior in the pressure vessel 2.

In the pressure plate 32, a feed channel 37 is shown on the left-hand side, through which the feed liquid enters the first compartment 17a and flows along the outside of the membrane pockets 20 from left to right in FIG. 10. The continuous edge seal 21 of the membrane pockets 20 can also be seen. Once the feed flow has passed through the first compartment 17a from left to right, it reaches the opening 16a in the first baffle plate 16 through which it enters the second compartment 17b, passing through the latter from right to left in FIG. 10. Then, it reaches the next opening in the next baffle plate 16 through which it enters the next compartment 17c. In this way, the baffle plates 16 and the alternating arrangement of the openings 16a in said baffle plates 16 make the feed meander through the membrane module 1, so that the feed flows along the membrane pockets 20 several times and has several opportunities of discharging the minority component dissolved in the feed to the permeate.

In the membrane pocket stack 15, slot-like permeate channels 40 are located between the tie rods 33, which permeate channels are formed by the successive slots 22 in the membrane pockets 20. Said channels are each supported by a porous support tube 43 (shown by dash-dotted lines) in the exemplary embodiment according to FIG. 10. The support tubes 43 prevent the permeate channels 40 from collapsing when negative pressure is applied to the permeate outlets 42. Said permeate channels 40 and porous support tubes 43 open into a permeate tube 41 which opens into permeate outlets 42 on both sides.

A circle in the right-hand part of FIG. 10 and the letter “X” indicate a section of the membrane pocket stack 15 which is shown in detail in FIG. 11 and illustrates the detailed structure of the membrane pocket stack 15.

According to said figure, each membrane pocket 20 comprises a continuous edge seal 21, which may be welded and where the membranes forming the membrane pocket 20 are tightly connected to one another. Towards the inside, the membranes of the membrane pocket at first diverge and then extend in parallel, thus forming the actual membrane pocket 20. As the membrane pocket 20 would collapse when negative pressure is applied, permeate spacers 52 to 55 are arranged inside the membrane pocket 20. A big permeate spacer 55 is arranged at the centre, which is surrounded by finer permeate spacers 54 on both sides. These are again surrounded by very fine permeate spacers 53 on their outside. The latter may, in addition, be surrounded by a web 52. The permeate spacers 53, 54 and 55 may, for example, consist of layers of synthetic threads which are laid on one another crosswise and whose fineness increases towards the outside, while the web has an irregular structure.

In addition, metal pressure plates 60 are arranged on the inner sides of the membranes of the membrane pockets 20 in FIG. 11, which plates give additional stability to the membrane pockets 20. In particular, they serve as an abutment for slot seals 65 arranged between successive membrane pockets 20, in order to reliably separate the permeate chamber 27 inside the membrane pockets 20 and in the permeate channels 40 from the feed chamber 26 outside the membrane pockets 20. Both the metal pressure plates 60 and the slot seals 65 are only located in or around the membrane pockets 20 in the immediate vicinity of the slot-like permeate channels 40.

FIGS. 12a), 12b) show a schematic view of a slot seal 65. FIG. 12a) shows a top view in the direction of the permeate channels 40. In this view, the slot seal 65 comprises a continuous bead made of a sealing material 67, for example an elastic material, for example rubber. A sheet-like frame 66 has openings 68 for tie rods 33 and openings 69 for permeate channels 40. Such a slot seal 65 is inserted between successive membrane pockets 20 at the position of the permeate channels 40 and of the tie rods 33.

FIG. 12b) shows a more enlarged cross-sectional view of the slot seal 65 along the cutting line A-A of FIG. 12a). In this cross-sectional view, the slot seal 65 has the central opening 69 for a permeate channel 40. Said opening is limited by a frame 66 on the upper and lower sides, which has the relevant opening 69 in said position. The frame 66 includes the sealing material 67 on its sides, which adjoins the frame 66 in the form of a bead.

FIG. 13 shows a corresponding metal pressure plate 60 in the same perspective view as the slot seal 65 of FIG. 12a). The metal pressure plate 60 according to FIG. 13 is a flat body made of an incompressible material, for example a metal or a plastic, whose circumference and arrangement of openings 31 for tie rods 33 and openings 62 for permeate channels 40 correspond to the arrangement of the openings 68 and 69 of the slot seal 65 of FIG. 12a). The metal pressure plate 60 is arranged in the membrane pockets 20 and serves as an abutment for the slot seals 65 in order to absorb the compressive loads exerted when the tie rods 33 are tensioned.

All features mentioned above, also those that can only be seen in the drawings and also individual features disclosed in combination with other features, are essential to the invention alone and in combination. Embodiments of the invention may either comprise individual features or a combination of several features.

### LIST OF REFERENCE NUMERALS

1 Membrane module

2 Cylindrical pressure vessel

3 Front plate

4 Rear plate

5 Feed connection piece

6, 6′ Retentate connection piece

6a Retentate channel

7 Permeate connection piece

11 Inner container

12 Feed inlet

13, 13′ Retentate outlet

14 Permeate outlet

15 Membrane pocket stack

16 Baffle plate

16a Opening

17a-17f Compartment

18 Interior space

20 Membrane pocket

21 Edge seal

22 Slot-like opening for a permeate channel

23 Feed flow

24 Retentate flow

25 Permeate flow

26 Feed chamber

27 Permeate chamber

30 End plate

31 Top plate

32 Pressure plate

33 Tie rod

34 Nut

35, 35′ O ring

36 Tensioning nut

37 Feed channel

40 Permeate channel

41 Permeate tube

42 Permeate outlet

43 Porous support tube for the permeate channel

51 Feed spacer

52 Web

53 Very fine permeate spacer

54 Fine permeate spacer

55 Coarse permeate spacer

60 Metal pressure plate

61 Opening for tie rod

62 Opening for permeate channel

65 Slot seal

66 Frame

67 Sealing material

68 Opening for tie rod

69 Opening for permeate channel

100 Plate module

101 Feed

102 Retentate

103 Permeate

104 Upper plate

105 Lower plate

106 Feed plate

107 Seal

108 Membrane

109 Perforated metal sheet

110 Permeate channel spacer

200 Plate module

201 Feed

202 Retentate

203 Permeate

204 Cover plate

205 Membrane plate

206 Membrane

207 Intermediate plate

208 Profile

209 End plate

210 Feed channel

211 Retentate channel

212 Permeate channel

300 Spirally wound module

301 Feed

302 Retentate

303 Permeate

304 Perforated tube

305 Membrane

306 Permeate spacer

307 Feed spacer

400 Membrane module

401 Feed

402 Retentate

403 Permeate

404 Container

405 Permeate tube

406 Feed inlet

407 Retentate outlet

408 Baffle plate

409 Membrane pocket

410 O ring

420 Feed flow

421 Retentate flow

422 Permeate flow

1. A membrane module (1) for pervaporation, in particular organophilic pervaporation, having a liquid-tight housing (11) with at least one feed inlet (12, 37), at least one retentate outlet (6a, 13, 13′) and at least one permeate outlet (14, 42) that is or can be subjected to a negative pressure or vacuum, wherein a membrane pocket stack (15) is arranged in a housing interior (18) and comprises a plurality of membrane pockets (20) and seals (65) laid on one another, wherein mechanical pressure is or can be applied to the membrane pockets (20) in the stacking direction by means of a pressure application device (32, 33) for the mutual sealing of the membrane pockets (20), so that the housing interior (18) is divided up by the membrane pockets (20) into a feed chamber (26) on the outside of the membrane pockets (20) and a permeate chamber (27) inside the membrane pockets (20), characterized in that the membrane pockets (20) have a substantially rectangular cross-section and, in their membrane surfaces, have openings (22) in the form of slots, wherein the slot-like openings (22) arranged on one another in the membrane pocket stack (15) and the seals (65) located therebetween form at least one common permeate channel (40), which leads to the at least one permeate outlet (14).

2. The membrane module (1) according to claim 1, characterized in that the slot-like openings (22) are arranged on the longer one of the two axes of symmetry of the membrane pockets (20).

3. The membrane module according to claim 2, characterized in that the at least one permeate channel (40) opens into a permeate tube (41) which is located on one side of the membrane pocket stack (15) and has one or several permeate outlet(s) (14, 42).

4. The membrane module (1) according to claim 3, characterized in that porous permeate spacers (52 55) are arranged in the membrane pockets (20), and/or porous feed spacers (51) are arranged between membrane pockets (20) in the membrane pocket stack (15).

5. The membrane module (1) according to claim 4, characterized in that several permeate spacers (52 55) are arranged in layers in the membrane pockets (20), and the fineness of said permeate spacers as regards their porosity increases from the inside outwards.

6. The membrane module (1) according to claim 5, characterized in that, in addition, one or several metal pressure plates (60) are arranged within the membrane pockets (20) between the membrane and a permeate spacer (52 55).

7. The membrane module (1) according to claim 6, characterized in that a perforated support tube (43) is arranged in the at least one permeate channel (40) for stabilizing said permeate channel(s) (40), which support tube has substantially the same cross-section as the permeate channel (43).

8. The membrane module (1) according to claim 7, characterized in that the housing interior (18) is divided into several compartments (17a 17f) by means of baffle plates (16) arranged between individual membrane pockets (20), wherein said baffle plates (16) each comprise openings (16a) for passing a feed flow (23) from one compartment (17a 17e) to the next compartment (17b 17f), wherein said openings are arranged in an alternating manner in order to achieve a meandering feed flow (23) through the compartments (17a 17f).

9. The membrane module (1) according to claim 8, characterized in that the height of the compartments (17a 17f) and the number of membrane pockets (20) per compartment (17a 17f) decrease at least partially in the direction from the feed inlet (12) to the retentate outlet (23, 13′).

10. The membrane module (1) according to claim 9, characterized in that the housing (11) is arranged in a pressure vessel (2).

11. Use of a membrane module (1) according to claim 10 for pervaporative separation of liquid mixtures, in particular mixtures of organic solvents and organic substances dissolved therein.
